(19) United States
(12) Patent Application Publication
(10) Pub. No.: US 2020/0072589 A1
(43) Pub. Date: Mar. 5, 2020

(54) DIMENSIONAL LUMBER PRE-MARKED WITH MEASUREMENT MARKINGS

(71) Applicants: Joseph Wayne Kraft, II, College Station, TX (US); Joseph Wayne Kraft, Dallas, TX (US)

(72) Inventors: Joseph Wayne Kraft, II, College Station, TX (US); Joseph Wayne Kraft, Dallas, TX (US)

(21) Appl. No.: 16/115,687

(22) Filed: Aug. 29, 2018

(51) Int. Cl. G01B 3/04; G01B 1/00

(52) U.S. Cl. CPC G01B 3/04; G09F 7/16; G01B 1/00

(57) ABSTRACT

This device is designed to replace and improve upon traditional framing lumber commonly used in home and commercial construction projects. The main problem that is addressed in this proposed improvement is the time that it takes to measure and mark lumber to be cut to specific lengths for the purpose of construction. This device serves to address this problem by pre-marking the lumber with conventional dimensional measurements (inches, centimeters, etc) that can be easily seen and used by the craftsman when cutting the lumber to the desired length.

### FIELD OF INVENTION

This device refers to the field of building materials and more specifically to dimensional lumber.

### BACKGROUND OF THE INVENTION

Dimensional lumber is commonly used in home and commercial construction for framing purposes. Many times this lumber must be cut to specified lengths. To do this, the craftsman must use a measuring tape or other measuring instrument to measure the lumber and use a marking instrument to mark the lumber at the desired length in order to identify where it is to be cut. By removing this currently necessary step of measuring and marking the lumber the craftsman could save significant time during the construction process and this would in turn save money. This proposed improvement upon currently available dimensional lumber would not at all change the size or shape of traditional lumber. The difference with this new improved lumber design would be to have markings with measurements printed or stamped onto the wood running the length of both sides of the lumber. One embodiment could have markings for measurements in inches, with the smallest increment of ⅛ inch printed on each side or face of the lumber but beginning from opposite ends. This would allow for a piece of lumber being cut to length and then another shorter piece can still be cut to another desired length from the discarded end of the board. This same marking system could be utilized with flat stock lumber such as plywood or particle board by having two dimensional grid markings printed on one side of the sheet of material. This would greatly facilitate making perpendicular cuts on flat stock lumber.

### SUMMARY

The current invention is a device that is designed to replace and improve upon traditional framing lumber commonly used in home and commercial construction projects. The main problem that is addressed in this proposed improvement is the time that it takes to measure and mark lumber to be cut to specific lengths for the purpose of construction. This device serves to address this problem by pre-marking the lumber with conventional dimensional measurements (inches, centimeters, etc) that can be easily seen and used by the craftsman when cutting the lumber to the desired length.

### BRIEF DESCRIPTION OF THE DRAWINGS

Without restricting the full scope of this invention, the preferred form of this invention is illustrated in the following drawings:

FIG. 1 is a drawing of the proposed dimensional lumber with measurement markings in place; and

FIG. 2 shows a drawing of the proposed flat stock lumber.

### DESCRIPTION OF THE INVENTION

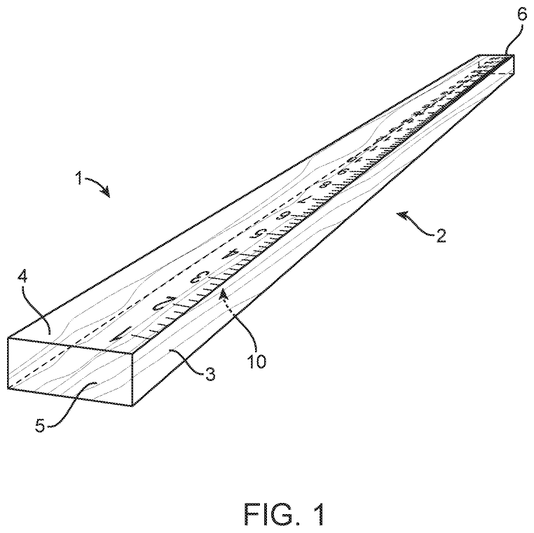

The proposed improvement utilizes measurement markings 10 stamped or printed onto the face surfaces of traditional lumber 1 in order to be able to reduce construction time by eliminating the measuring and marking steps involved. The lumber would be milled according to current milling practices and subsequently stamped or marked with the measurement markings. This system can be utilized for both dimensional lumber such as 2×4s, 2×6s etc. as well as flat stock lumber such as plywood, chipboard, MDF or particle board. With the dimensional lumber 1 there could be, but is not limited to, markings 10 along the edge of the face surfaces that would be most beneficial to right-handed craftsmen or possibly extending across the entire face surface as demonstrated in the drawings. The actual location of the markings 10 could be determined by market analysis. The opposite face could also be marked in the same fashion, with the only difference that it could begin the measurements from the other end of the board as demonstrated in the drawings as shown in FIG. 1.

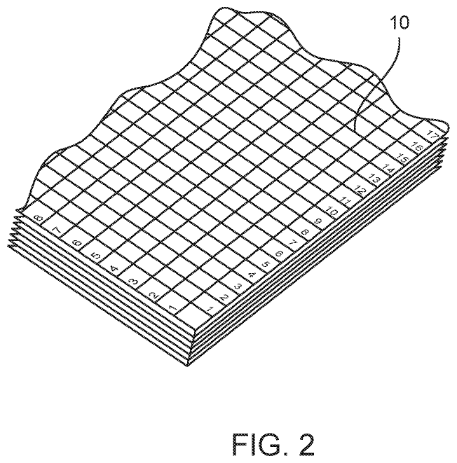

With regards to flat stock lumber such as plywood, there could be a square grid pattern stamped or printed on the surface with squares being 1 inch or ½ inch on a side with the actual increments to be determined by market analysis. This would allow for much easier cutting of these large pieces of lumber by providing guidelines identifying true perpendicular or parallel lines as shown in FIG. 2. These markings of course would only be of significant benefit when using lumber that is to be covered up or if the appearance is not an issue. Examples of situations in which this could be very useful would be in wall framing when the lumber would eventually be covered by sheetrock or other finished wall surface. The same is true for subfloor, roof decking or wall sheathing where the finished flooring, roofing material, or exterior wall finish would cover over the flat stock lumber used in the underlayment.

FIG. 1 shows the proposed dimensional lumber with measurement markings 10 in place. This embodiment depicts the incremental measurements printed on front face 1 adjacent to right edge 3 with the numbers originating from proximal end 5. The opposite face referred to as rear face 2, would also have incremental measurements printed on it as well. They would be printed similarly but adjacent to a left edge 4 and originating from a distal end 6. Another embodiment would have the increment lines running transverse across the entire faces of the lumber

FIG. 2 shows flat stock lumber such as plywood, chipboard, or particle board with proposed grid markings 10 in place. This embodiment has markings 10 only on the whole integer of the measurement, however any fraction of a conventional unit of measure could also be used depending on market analysis. The markings 10 can be in a grid pattern.

As to a further discussion of the manner of usage and operation of the present invention, the same should be apparent from the above description. Accordingly, no further discussion relating to the manner of usage and operation will be provided. With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

That which is claimed is:

1. A device comprising;
Lumber having a front face, a rear face, a right edge, a left edge, a proximal end and a distal end surfaces where incremental measurement markings printed on one or more surfaces of the lumber.

2. The device according to claim 1 further comprising where the lumber and where the incremental measurements are printed on front face.

3. The device according to claim 1 further comprising where the lumber and where the incremental measurements are printed on right edge of the front face.

4. The device according to claim 1 further comprising where the lumber and where the incremental measurements are printed on left edge of the rear face.

5. The device according to claim 1 further comprising where markings originate from the proximal end.

6. The device according to claim 1 further comprising where markings originate from the distal end.

7. The device according to claim 1 further comprising where markings are in a grid pattern.

8. The device according to claim 1 further comprising having the markings on a whole integer unit of the measurement.

9. A process using the device according to claim 1.
